(19) United States
(12) Patent Application Publication
(10) Pub. No.: US 2017/0369364 A1
(43) Pub. Date: Dec. 28, 2017

(54) STACKS INCLUDING SOL-GEL LAYERS AND METHODS OF FORMING THEREOF

(71) Applicant: Advenira Enterprises, Inc., Sunnyvale, CA (US)

(72) Inventors: Zoulfia Nagamedianova, Sunnyvale, CA (US); Jeff Dawley, Sunnyvale, CA (US); Elmira Ryabova, Sunnyvale, CA (US); Christopher Mah, Sunnyvale, CA (US)

(73) Assignee: Advenira Enterprises, Inc., Sunnyvale, CA (US)

(21) Appl. No.: 15/631,463

(22) Filed: Jun. 23, 2017

Related U.S. Application Data
(60) Provisional application No. 62/354,662, filed on Jun. 24, 2016.

(51) Int. Cl. C03C 17/00; B32B 17/10; C03C 23/00; C09D 1/00; C09D 7/12; C03C 17/34

(52) U.S. Cl. CPC C03C 17/007; C09D 7/1266; C03C 17/3417; C03C 23/0075; C09D 1/00; B32B 17/10761; B32B 2605/006; C03C 2217/213; C03C 2217/78; C03C 2217/212

(57) ABSTRACT

Provided are methods of forming stacks comprising a substrate and one or more sol-gel layers disposed on the substrate. Also provided are stacks formed by these methods. The sol-gel layers in these stacks, especially outer layers, may have a porosity of less than 1% or even less than 0.5%. In some embodiments, these layers may have a surface roughness (Rₐ) of less than 1 nanometers. The sol-gel layers may be formed using radiative curing and/or thermal curing at temperatures of between 400° C. and 700° C. or higher. These temperatures allow application of sol-gel layers on new types of substrates. A sol-gel solution, used to form these layers, may have colloidal nanoparticles with a size of less than 20 Angstroms on average. This small size and narrow size distribution is believed to control the porosity of the resulting sol-gel layers.

### CROSS-REFERENCE TO RELATED APPLICATIONS

This application claims the benefit under 35 U.S.C. §119(e) of US Provisional Patent Application 62/354,662, entitled: “Stacks Including Sol-Gel Layers and Methods of Forming Thereof” filed on Jun. 24, 2016, which is incorporated herein by reference in its entirety for all purposes.

### BACKGROUND

Sol-gel refers to a process, in which monomeric and/or oligomeric species (e.g., metal organic species) are dispersed in a liquid and react through hydrolysis and condensation reactions to form colloidal particles. These colloidal particles may agglomerate together to form three-dimensional networks within the liquid. Sol-gel materials, including these colloidal particles and liquids in which these colloidal particles dispersed, may be referred to as sol-gel solutions or sol-gel coating materials. Sol-gel solutions are used to form layers or coatings or, more specifically, sol-gel layers or sol-gel coatings. The properties of sol-gel layers depend at least in part on the properties of sol-gel solutions used to form these layers, as further described below.

Conventional sol-gel layers are highly porous and have high surface roughness. Furthermore, these conventional layers are generally not scratch resistant. In some applications, high porosity may be desirable, e.g., for layers having low refractive indices. On other hand, the high porosity and other characteristics may prevent implementation of the conventional sol-gel layers in other applications. For example, nonporous scratch resistant layers may be used to form external surfaces without a need for any additional protective layers.

Forming sol-gel layers with low porosity characteristics has been challenging, and such sol-gel layers are generally not available. First, conventional sol-gel layers often experience micro-phase separation and cluster formation during their deposition and initial curing (e.g., solvent removal) increasing porosity. Furthermore, uncontrolled agglomeration of colloidal particles in sol-gel solutions leads to gels with a high porosity. When these gels are cured, the porosity remains and often further increases while removing organic components. This phenomenon is often referred to as a “residual porosity” and is very common in conventional sol-gel layers. In general, the porosity of conventional sol-gel layers may be at least about 10% or even at least about 20%.

What is needed are sol-gel layers having low porosity (e.g., less than 1%) and methods of forming these sol-gel layers.

### SUMMARY

Provided are methods of forming stacks comprising a substrate and one or more sol-gel layers disposed on the substrate. Also provided are stacks formed by these methods. The sol-gel layers in these stacks, especially outer layers, may have a porosity of less than 1% or even less than 0.5%. In some embodiments, these layers may have a surface roughness (Rₐ) of less than 1 nanometer. The sol-gel layers may be formed using radiative curing and/or thermal curing at temperatures of between 400° C. and 700° C. or higher. These temperatures allow application of sol-gel layers on new types of substrates. A sol-gel solution, used to form these layers, may have colloidal nanoparticles with a size of less than 20 Angstroms on average. This small size and narrow size distribution is believed to control the porosity of the resulting sol-gel layers.

In some embodiments, a method of forming a stack comprises providing a substrate. The substrate, which may be a glass substrate, has a first surface and a second surface. The method then proceeds with forming a first sol-gel layer over the first surface of the substrate. In some embodiments, the first sol-gel layer may be formed directly on the first surface. Alternatively, another structure (e.g., another sol-gel layer) may be disposed between the first sol-gel layer and the substrate. In some embodiments, the first sol-gel layer may form an outer surface of the stack. The first sol-gel layer may have a porosity of less than 1%.

Forming the first-sol gel layer may involve radiative curing and/or a thermal curing. The thermal curing may be performed at a temperature of between 400° C. and 700° C. (e.g., for soda-lima glass). Different temperatures may be used for other types of substrates. For example, higher temperatures may be used borosilicate, alumosilicate glasses, glass-ceramic materials, and the like.

In some embodiments, forming the first sol-gel layer is performed in an air-containing environment. This environment may have a relative humidity level of between 20% and 70% for temperatures of 20 to 25° C.

Forming the first sol-gel layer may comprise distributing a sol-gel solution over the first surface of the substrate. The sol-gel solution comprises colloidal nanoparticles that have the size of less than 20 Angstroms on average or, more specifically, less than 10 Angstroms on average. As noted above, the size of these colloidal nanoparticles may be used to control porosity of the first sol-gel layer.

In some embodiments, the method further comprises treating the first surface. The first surface is treated prior to forming the first sol-gel layer over or, more specifically, directly on the first surface. For example, the first surface may be treated using a pretreating solution. The pretreating solution may comprise sodium carbonate and/or sodium dodecylbenzenesulfonate.

In some embodiments, forming the first sol-gel layer comprises changing the shape of the substrate. For example, the shape of the substrate may be changed while curing the sol-gel solution. Combining these operations may simplify and expedite the overall process.

In some embodiments, the method further comprises laminating the substrate to an additional substrate. The substrate may be laminated after forming the first sol-gel layer. In other words, the substrate comprising the first sol-gel layer may be laminated to the additional substrate. The additional substrate may be laminated to the second surface of the substrate, which is opposite of the first sol-gel layer. Alternatively, the additional substrate may be laminated over the first sol-gel layer such that the first sol-gel layer is disposed between the additional substrate and the original substrate. Furthermore, the additional substrate may be laminated before forming the first sol-gel layer.

The first sol-gel layer may comprise one or more of the following materials: silicon oxide, magnesium fluoride, aluminum oxide, or a mixture of the materials. The concentration of these materials in the first sol-gel layer may be at least about 99% atomic or even at least about 99.5% atomic.

In some embodiments, the first sol-gel layer has a refractive index of between about 1.4 and 1.6 or, more specifically, between about 1.45 and 1.55. The first sol-gel layer may be stacked with one or more other sol-gel layers having different refractive indices.

In some embodiments, the method further comprises forming a second sol-gel layer over the first surface of the substrate. The second sol-gel layer may have a porosity of less than 1% or, more specifically, less than 0.5%. Forming the second sol-gel layer may comprise radiative curing or a thermal curing at a temperature of between 400° C. and 700° C. Higher temperatures may be used for substrates comprising borosilicate, aluminosilicate glasses, glass-ceramic materials, and the like.

The composition of the first sol-gel layer may be different from composition of the second sol-gel layer. The second sol-gel layer may comprise one or more of the following materials: titanium oxide, zirconium oxide, niobium oxide, tantalum oxide, cerium oxide, hafnium oxide, and transparent conductive oxides (TCO) based on zinc oxide, tin oxide, indium oxide or mixtures thereof.

The refractive index of the first sol-gel layer may be less than a refractive index of the second sol-gel layer. In some embodiments, the refractive index of the first sol-gel layer is between about 1.4 and 1.6, while the refractive index of the second sol-gel layer is between about 2.0 and 2.6. The second sol-gel layer may be disposed between the substrate and the first sol-gel layer. More specifically, the second sol-gel layer may directly interface the substrate and may also directly interface the first sol-gel layer.

Also provided is a stack comprising a substrate and a first sol-gel layer. The substrate has a first surface and a second surface. The first sol-gel layer is disposed over the first surface of the substrate and may form an outer surface of the stack. In some embodiments, the outer surface formed by the first sol-gel layer is exposed. The first sol-gel layer has a porosity of less than 1% or, more specifically, less than 0.5%. The outer surface of the stack has a surface roughness (Rₐ) of less than 10 nanometers or less than 1 nanometer.

In some embodiments, the first sol-gel layer may directly interface the first surface of the substrate. Alternatively, another structure (e.g., one or more other sol-gel layers) may be disposed between the first sol-gel layer and the substrate. The second surface of the substrate may be exposed. Alternatively, the second surface of the substrate may interface another sol-gel layer or laminated to another substrate.

The first sol-gel layer may comprise one or more materials of the following materials: silicon oxide, magnesium fluoride, and aluminum oxide, and a mixture thereof. The concentration of these materials in the first sol-gel layer may be at least about 99% atomic. The first sol-gel layer may have a refractive index of between about 1.4 and 1.6.

In some embodiments, the stack further comprises a second sol-gel layer. The second sol-gel layer may be disposed between the substrate and the first sol-gel layer. The composition of the first sol-gel layer may be different from composition of the second sol-gel layer. The second sol-gel layer may comprise one or more of the following materials: titanium oxide, zirconium oxide, niobium oxide, tantalum oxide, cerium oxide, and hafnium oxide and transparent conductive oxides (TCO) based on zinc oxide, tin oxide, and indium oxide. The concentration of the material in the second sol-gel layer is at least about 99% atomic. The second sol-gel layer may have a porosity of less than 1%.

The refractive index of the first sol-gel layer may be less than the refractive index of the second sol-gel layer. For example, the refractive index of the first sol-gel layer may be between about 1.4 and 1.6, while the refractive index of the second sol-gel layer is between about 2.0 and 2.6.

In some embodiments, the stack further comprises a third sol-gel layer and a fourth sol-gel layer. The third sol-gel layer may be disposed over the second surface of the substrate such that the substrate is disposed between the first sol-gel layer and the third sol-gel layer. The composition of the third sol-gel layer may be the same as the composition of the first sol-gel layer. The third sol-gel layer may be disposed over the fourth sol-gel layer such that the fourth sol-gel layer is disposed between the substrate and the third sol-gel layer. The composition of the second sol-gel layer is same as the composition of the fourth sol-gel layer.

In some embodiments, the substrate comprises a glass sheet. More specifically, the substrate may comprise two glass sheets laminated together using polyvinyl butyral (PVB).

### BRIEF DESCRIPTION OF DRAWINGS

FIGS. 1A-1G are different examples of a stack comprising a substrate and one or more sol-gel layers.

FIG. 2 is a process flowchart corresponding to a method of forming the stack shown in FIGS. 1A-1G, in accordance with some embodiments.

FIG. 3 illustrates a scanning electron microscope (SEM) image of an interface formed by a glass substrate and a sol-gel layer described herein

FIGS. 4A-4D illustrate experimental results of testing coated and uncoated glass substrates.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### INTRODUCTION

Sol-gel materials and, in particular, sol-gel layers disposed on substrates are gaining traction for new application and become more popular because of their relatively simple deposition techniques. However, conventional sol-gel layers have various limitations and drawbacks that restrict widespread use. For example, conventional sol-gel layers tend to have a high porosity (e.g., greater than 10% or even greater than 20%), which also leads to poor mechanical properties. For example, Taber abrasion resistance after 1,000 cycles (according to ASTM D1044) yields the haze value change of at least 2.0% for most conventional sol-gel layers. Such layers cannot be used for many types of external (outside) surfaces, such as on automotive glass, some types of architectural glass, solar panel covers, and the like. For example, ANSI/SAE Z26.1/1996 (Safety Glazing Materials for Glazing Motor Vehicles and Motor Vehicle Equipment Operating on Land Highways—Safety Standard) requires abrasion resistance of less than 2% based on changes in light scattered after 1,000 cycles of abrasion. This requirement has so far prevented sol-gel layers from being used for external (outside) surfaces on automotive glass.

High porosity of conventional sol-gel layers may be attributed to various factors. One factor is a microstructure of polymeric chains formed in sol-gel solutions during hydrolysis and condensation of various components forming these solutions. Different synthesis conditions of a sol-gel solution may yield different types of structures, ranging from weakly branched polymers to fully condensed particles. For example, in the case of silica polymerization, pH and temperature of a sol-gel solution play a significant role in final propertied of the formed sol-gel layer. The isoelectric point of silica is close to pH of 2. In this example, high pH and/or high temperature of the solution promotes higher cross-linking between polymer chains. This, in turn, causes formation of larger colloidal particles (e.g., in the form of highly branched clusters or agglomerates) in the sol-gel solution. These large colloidal particles, in turn, cause high porosity in a silica sol-gel layer formed from this type of sol-gel solution. When a low H₂O/Si ratio, low pH, and/or low temperatures are used to synthesize a sol-gel solution, the resulting polymer chains are weakly cross-linked in the solution and can be compacted before further cross-linking occurs. The resulting silica sol-gel layer formed from this type of sol-gel solution is less porous. In general, promoting the nucleation process and, at the same time, slowing the growth of particles/agglomerates in a sol-gel solution translates in smaller colloidal nanoparticles and less porosity in a sol-gel layer formed from this solution.

In addition to compact formation of colloidal particles and small average particle size, the narrow size distribution of these particles is another factor that helps with achieving low porosity in the formed sol-gel layer. The narrow size distribution may be achieved by preventing agglomeration of primary colloidal particles as well as achieving good dispersion of the particles in the sol-gel solution while it is being synthesized and used. For example, charge stabilization agents and/or encapsulation agents may be added to the solution to prevent agglomeration of the colloidal particles.

Without being restricted to any particular theory, it is believed that using a sol-gel solution comprising ultra-small particles (e.g., colloidal nanoparticles) having uniform size/narrow size distribution will result in highest packing efficiencies in the formed sol-gel layer. Furthermore, sintering of a sol-gel layer, while it is being cured, may be further decrease the porosity. For example, the minimum theoretical porosity of the hexagonal close-packing arrangement of identical rigid spheres is about 26%. Sintering may change this arrangement and reduce the porosity.

For purposes of this disclosure, a sol-gel solution distributed on a substrate surface may be referred to as a wet sol-gel layer. A cured and, in some embodiments, sintered sol-gel layer may be referred to a dry sol-gel layer, a formed sol-gel layer, or simply a sol-gel layer.

The curing/drying process may involve evaporation of one or more organic solvents from the wet sol-gel layer as well as removal of organic components and by-products of decomposition form the wet sol-gel layer. Also, hydroxyl (—OH) groups may be eliminated when, for example, the temperature reaches 400° C.-500° C. Furthermore, the overall curing operation may also involve a sintering operation. The sintering may be performed at higher temperatures than the rest of the curing operation. The sintering temperatures may be below the melting point of the substrate and below the melting point of the formed sol-gel layer. At the same time, the temperatures may be at the level where the diffusional mass transport within the sol-gel layer is sufficient. Furthermore, complex processes of intraparticle/interparticle diffusion may be possible during the sintering operation.

Typically, sintering of ceramic particles is performed at elevated temperatures, e.g., temperatures close to the softening point of these particles. However, such elevated temperatures may be damaging to other components in a stack (e.g., substrate) and may also require more thermal power (to bring the stack to this temperature). It has been found that sintering temperatures can be lowered substantially, when sintering nanosized particles, in comparison to larger particles. For purposes of this disclosure, the nanosized particles are referred to as particles having an average size of less than 100 nanometers. Specifically, it is believed that the melting temperature is a function of a particle size for nanosized particles (in addition to being a function of the particle composition/material). For example, course silica (micro-sized particles having an average size of 1.6 micrometers) require a sintering temperature of about 1600° C., while nanosized silica (particles having an average size of 20-100 nanometers) can be sintered at 900° C.-1200° C.

Sol-gel solutions described herein comprise colloidal particles. In some embodiments, the colloidal nanoparticles have an average size of less than 20 nanometers, less than 10 nanometers, less than 1 nanometer, and even less than 0.1 nanometers. As described above, having such small colloidal nanoparticles in the solution allows using an effective sintering process at low temperatures (e.g., 400° C.-700° C. or, more specifically, between 600° C.-650° C.). Even these low sintering temperatures produce low porosity/high density sol-gel layers, e.g., layers having porosity of less than 1% and even less 0.5%. As a reference, the minimum porosity for sol-gel ceramic layers sintered at 500° C.-700° C. was reported to be at least 10%.

The low temperature sintering allows using new substrate materials that may not be able to resist conventional sintering temperatures (e.g., temperatures greater than 700° C. or even greater than 900° C.). For example, soda-lime glass has to be processed at temperatures below than its softening point, which is about 695° C.-730° C., thereby limiting high temperature sintering. Going above this softening point, the viscosity of soda-lime glasses drops below 10⁸ Poise and undesirable plastic deformation may occur, causing undesirable changes in the final product shape, form, and aesthetic.

### Examples of Stacks Comprising Sol-Gel Layers

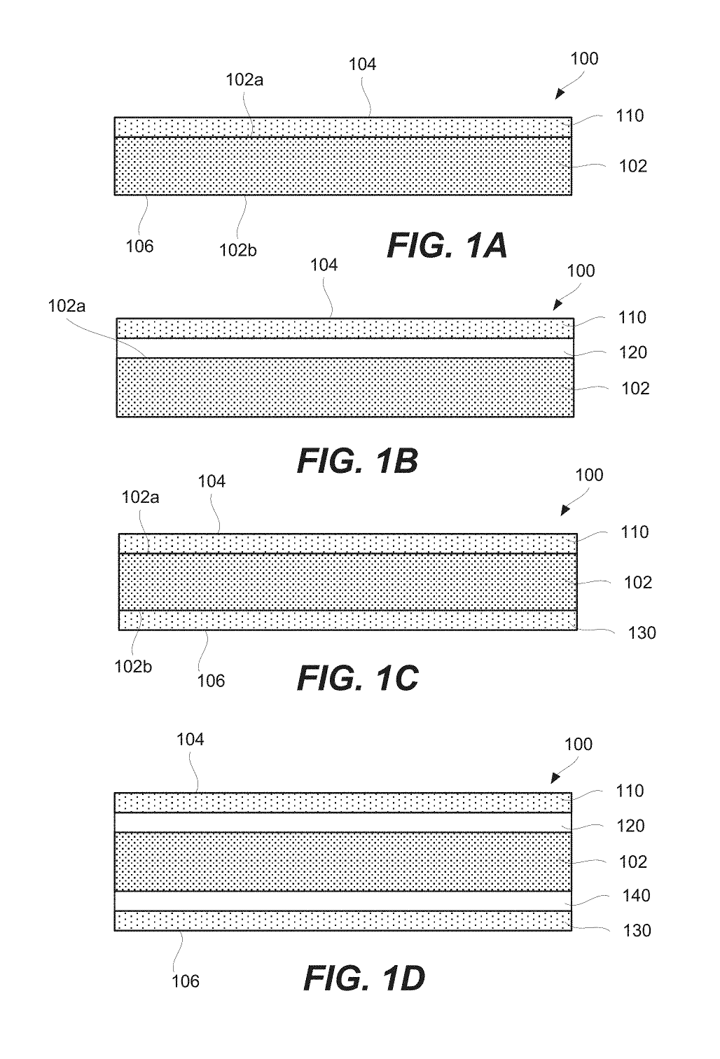

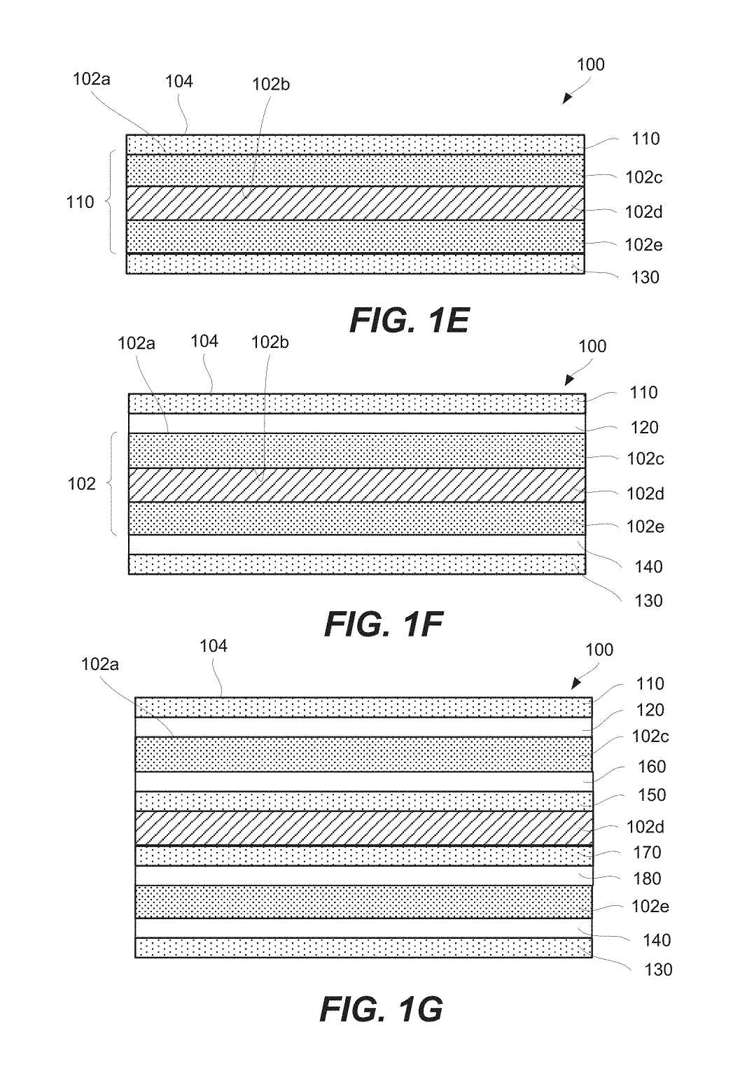

FIGS. 1A-1G are different examples of stack 100 comprising substrate 102 and at least one sol-gel-layer 110, which may be also referred to as a first sol-gel layer 110. Substrate 102 has first surface 102a and second surface 102b. First sol-gel layer 110 may be disposed over first surface 102a of substrate 102. Referring to FIG. 1A, first sol-gel layer 110 may directly interface first surface 102a of substrate 102. Alternatively, another structure may be disposed between first sol-gel layer 110 and substrate 102 as described below with reference to FIGS. 1B and 1D.

In some embodiments, first sol-gel layer 110 forms outer surface 104 of stack 100. In these embodiments, first sol-gel layer 110 may be also referred to as an outer layer of stack 100. Outer surface 104 of stack 100 may be exposed.

Referring to FIGS. 1A and 1B, second surface 102b of substrate 102 may be exposed. Alternatively, second surface 102b may be covered with another sol-gel layer, e.g., third sol-gel layer 130 as, for example, shown in FIG. 1C.

Some examples of substrate 102 include, but are not limited to, soda-lime glass, borosilicate glass, aluminosilicate glass, fused quartz glass, fluoroaluminate, germane-oxide, glass-ceramic materials, plastics, metals, and ceramics. In general, all types of silicate glasses and other types of glasses are within the scope. Substrate 102 can be transparent or non-transparent.

In some embodiments, the glass transition temperature of substrate 102 may be between about 520° C. and 600° C. e.g., for soda-lime glass. Such substrates may not be used with conventional sol-gel layers because of high temperatures required for their processing.

In some embodiments, substrate 102 may comprise two glass sheets 102c and 102e laminated together using intermediate layer 102d as, for example, shown in FIGS. 1E and 1F. Intermediate layer 102d may comprise polyvinyl butyral (PVB).

First sol-gel layer 110 may comprise one or more of the following materials: silicon oxide, magnesium fluoride, aluminum oxide, titanium oxide, zirconium oxide, niobium oxide, tantalum oxide, cerium oxide, hafnium oxide and transparent conductive oxides (TCO) based on zinc oxide, tin oxide, indium oxide or mixtures thereof. The concentration of these materials of, more specifically, one of these materials in first sol-gel layer 110 may be at least about 99% atomic. It should be noted that such a high purity of first sol-gel layer 110 may be achieved despite low curing temperatures used while forming first sol-gel layer 110, as further described below.

First sol-gel layer 110 may have a thickness of 5 nanometers to 1,000 nanometers or, more specifically, between about 10 nanometers and 500 nanometers or even between about 50 nanometers and 250 nanometers. The layer thicknesses of each sol-gel layer in stack 1100 may be selected to yield, for example, an optical interference filter designed according to the quarter wavelength optical thickness rule. In some example, the thickness may be selected to maximize IR and UV reflections while minimizing the visible light reflection.

First sol-gel layer 110 may have a porosity of less than 1% or, more specifically, less than 0.5% or even less than 0.3%. As described above, such low porosity values are generally not achievable in conventional sol-gel layers formed using conventional sol-gel solutions. Furthermore, the low porosity is evidenced in other characteristics of first sol-gel layer 110, such as its surface roughness, scratch resistance, refractive index, and the like.

Outer surface 104 of stack 100 (e.g., formed by first sol-gel layer 110) may have a surface roughness (Rₐ) of less than 10 nanometers, less than 1 nanometer, or even less 0.5 nanometers. With such a smooth surface, stack 100 may be used for modern displays, electronics, insulating pyrolytic low-E (low-emissivity) glasses, and the like. For example, conventional pyrolytic low-E glasses include transparent conductive oxide (TCO) layers, which are typically deposited by sputtering or chemical vapor deposition (CVD). These conventional glasses have various short-comings due to their higher roughness, i.e., greater than 5 nanometers Ra or even greater than 10-15 nanometers Ra. Specifically, their surfaces have randomly distributed peaks with a height of up to several tens of nanometers. These peaks cause problems with electrical break-down as electrical field is higher at these peaks. In other words, the peaks function as concentrated field points that eventually initiate the overall breakdown process.

These dielectric breakdown issues can be overcome by using a sol-gel layer as a TCO layer or forming a sol-gel layer over a TCO layer with a high surface roughness. Addition of the smooth sol-gel layer effectively eliminates these peaks/concentrated field points and substantially increase the breakdown voltage. Furthermore, referring to pyrolytic TCO glasses or more generally to electronic glasses and Low-E (low emissivity) glasses or heat reflective glasses, a conventional process employs fluorine doped tin oxide (FTO), in cases where the emissivity factor could be enhanced by deposition of thick and rough layer with average roughness (Ra) of about 10-15 nanometers. Nevertheless, this approach is still prone to electrical break-down problems and increased haze (light scattering) of glasses. In some instances, the haze is 0.5-5% versus 0.1-0.2% for uncoated glass dur to the addition of the FTO layer.

Adding of an ultra-smooth sol-gel layer described herein (e.g., first sol-gel layer 11o shown in FIGS. 1A-1G), which also happens to be extra-hard, on the top of pyrolytic TCO glasses significantly reduces their surface roughness from Ra 10-15 nanometers (before the addition) to Ra of less than 1 nanometer (after the addition). This addition also has an impact on the haze value and emissivity level, e.g., being less than <10%. In some embodiments, stack 100 comprises a pyrolytic TCO glass (e.g., substrate 102) having surface 102a and sol-gel layer 110 disposed directly on surface 102a of the pyrolytic TCO glass (as, for example, shown in FIG. 1A). In this example, the sol-gel layer directly interfaces the pyrolytic TCO glass. While the surface roughness of the pyrolytic TCO glass is at least 5 nanometers, the surface roughness of the stack with the sol-gel layer forming the outer surface is less than about 1 nanometer due to the addition of this sol-gel layer.

In some embodiments, first sol-gel layer 110 is chemically resistant. As such, first sol-gel layer 110 may be applied on a glass substrate or stacks (e.g., conductive glasses, low emissivity glasses, and the like) as a protective, anti-corrosion, and/or diffusion barrier. The chemical resistance may be attributed at least in part to the low porosity and to the inert nature of the materials selected for the layer.

For example, conventional soda-lime silicate glasses leach alkali ions when interacting with water (e.g., from ambient). As a result, a de-alkalized surface layer is formed affecting the optical quality of the glass. Addition of a sol-gel layer described herein have demonstrated effective prevention of glass corrosion and even passing salt spray tests, which uncoated glass samples have failed. Furthermore, the impact of ambient and handling protection is observed when this sol-gel layer (which is hard) is applied onto silver-containing low-emissivity glasses (which are soft). Coated silver-containing low-emissivity glasses have successfully passed abrasion tests on wet and dry conditions and corrosion (salt, water, heat) tests, while uncoated silver-containing stack low-emissivity glasses failed these tests.

First sol-gel layer 110 may have a refractive index of between about 1.4 and 2.0 or, more specifically, between 1.5 and 1.7. First sol-gel layer 110 may be stacked with other layers (e.g., other sol-gel layers) that have different refractive indices.

First sol-gel layer 110 may have a superior abrasion resistance, in comparison to conventional sol-gel layers. In some embodiments, the wide-angle light scattering based on Taber abrasion resistance after 1,000 cycles (according to ASTM D1044) of first sol-gel layer 110 is less than 0.60% or even less than 0.40% for first sol-gel-layer, measured with concentrating area accessory (e.g., Taber abrasion holder). First sol-gel layer 110 may meet the ANSI/SAE Z26.1/1996 requirement, described above. Furthermore, these abrasion resistance values of first sol-gel layer 110 are generally an order of magnitude better than that for conventional sol-gel layers. It should be noted that the acceptable glass abrasion resistance for uncoated glass is about 1.30% or even 1.50%. Abrasion resistance of conventional sol-gel layers is even worse than for uncoated glass indicating that such layers cannot be used as external protective layers on glass. In other words, the presented sol-gel layers are extra hard layers with abrasion properties that are higher or at least compatible to that of a glass substrate. It should be noted that other mechanical properties as well as chemical, thermal, and humidity-resistance properties of the presented sol-gel layers also make them suitable for outside surface applications in particular for many types of previously uncoated and previously coated glasses.

Scratch resistance and abrasive resistance of sol-gel layers may be controlled using specific combinations of properties of the entire stack (e.g., properties of the substrate, substrate-layer interface, and layers). Some examples of these characteristics, include but are not limited to, chemical compatibility of the substrate to the sol-gel solution, cleaning and activation of the substrate surface prior deposition of the sol-gel solution, chemical bonds between the substrate surface and the sol-gel layer. These characteristics can be controlled to improve adhesion of the sol-gel solution (and later of the sol-gel layer) to the substrate surface and to maintain compatibility during drying and curing processes. Other considerations include thermal expansion of the sol-gel layer and substrate, shear strength, and elasticity of each component in the stack.

Referring to FIGS. 1B and 1D, stack 100 may further comprise second sol-gel layer 120. Second sol-gel layer 120 may be disposed between substrate 102 and first sol-gel layer 110. Second sol-gel layer 120 may comprise a material selected from the group consisting of titanium oxide, zirconium oxide, niobium oxide, tantalum oxide, cerium oxide, and hafnium oxide and transparent conductive oxides (TCO) based on zinc oxide, tin oxide, indium oxide or mixtures thereof. The concentration of the material in second sol-gel layer 120 is at least about 99% atomic. The composition of first sol-gel layer 110 may be different from composition of second sol-gel layer 120. For example, optical filters may be formed from silicon dioxide (SiO₂) as a bottom layer (e.g., second-sol gel layer 120) and titanium dioxide (TiO₂) as a top layer (e.g., first sol-gel layer 110). The thickness of these layers may be selected based on the quarter wave optical thickness rule.

Second sol-gel layer 120 may have a porosity of less than 1% or, more specifically, less than 0.5%. The refractive index of first sol-gel layer 110 may be less than the refractive index of second sol-gel layer 120. For example, the refractive index first sol-gel layer 110 may be between about 1.4 and 1.6, while the refractive index second sol-gel layer 120 may be between about 2.0 and 2.6. IR- or/and UV-reflective interference system for transparent substrates may be formed using at least two sol-gel layers having different refractive indices. Theses layers may be directly applied to the outside and/or inside surfaces of glass.

Referring to FIG. 1C, stack 100 may further comprise third sol-gel layer 130. Third sol-gel layer 130 may be disposed over second surface 102b of substrate 102, such that substrate 102 is disposed between first sol-gel layer 110 and third sol-gel layer 130. The composition of third sol-gel layer 130 may be same as the composition of first sol-gel layer 110. This example may be referred to as a mirror stack. Furthermore, the thicknesses of first sol-gel layer 110 and third sol-gel layer 130 may be the same.

Referring to FIG. 1D, stack 100 may further comprise fourth sol-gel layer 140, for example, in addition to third sol-gel layer 130 and second sol-gel layer 120. Fourth sol-gel layer 140 may be disposed under third sol-gel layer 130. The composition of second sol-gel layer 120 may be the same as the composition of fourth sol-gel layer 140.

Sol-gel layers described herein have been tested and proved to be compatible with traditional glass processes of tempering, bending (performed at high temperature industrial ovens at 400°−700° C.), and lamination with polyvinylbutyral (PVB) layer (laminated glass consist on 2 pieces of glass glued between with PVB-interlayer using pressure and heat). In laminated glass stacks, high performance solar control properties were achieved while conserving high visible light transmittance (Tvis) >70%, and efficient solar heat blockage with SHGC (solar heat gain coefficient) of less than 0.50 or even less than 0.45. For comparison, the SHGC of uncoated laminated glass is greater than 0.63. Furthermore, neutral color in transmission and reflection have been preserved while adding sol-gel layers. Finally, high abrasion, high corrosion resistance and high chemical resistance properties were maintained.

These sol-gel layer, operable as optical interference layers, may be applied to the outside surface of glass, providing higher UV-solar blockage and AR (anti-reflective) performance. The sol-gel layers also contribute to higher glass protection (increased abrasion and impact resistance), especially interesting for automotive laminated glass used in windshields. It should be noted that laminated glass has much weaker mechanical behavior compared to tempered side windows and, as a result, greatly benefits from protective coatings. Furthermore, sol-gel layers operable as solar control layer, have an advantage of being a non-metallic. This is an important aspect for propagating electromagnetic signals when wireless communication device, global positioning systems (GPS), and the like and used indoors.

FIG. 1G illustrates an example of stack 100 comprising multiple substrates 102c and 102e. Each substrate has multiple sol-gel layers disposed on each side of this substrate. For example, substrate 102c has sol-gel layers 110 and 120 on one side (outer side) and sol-gel layers 150 and 160 on the other side (inner side). Substrate 102e has sol-gel layers 130 and 140 on one side (outer side) and sol-gel layers 170 and 180 on the other side (inner side). These stacks are laminated together using intermediate layer 102d, which may comprise polyvinyl butyral (PVB), any type of clear, tinted or specially designed with additives/colloidal nanoparticles.

Some applications for stack examples shown in FIGS. 1A-1G include, but not limited, to optical filters or, more specifically, wide band anti-reflective layers, UV-reflective or IR-reflective (hot mirrors) layers, sensors transparent window for specific wavelength etc.

### Processing Examples

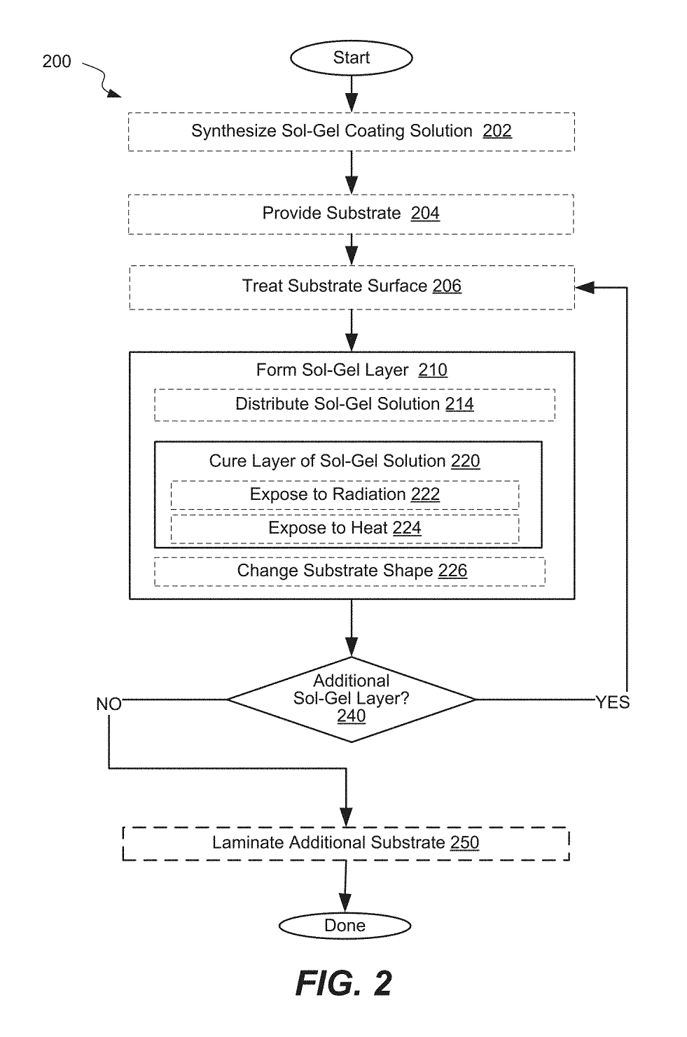

FIG. 2 is a process flowchart corresponding to method 200 of forming stack 100 shown in FIGS. 1A-1G, in accordance with some embodiments. In some embodiments, method 200 may commence with synthesizing a sol-gel solution, during optional operation 202. The sol-gel solution may comprise colloidal nanoparticles having a size of less than 20 Angstroms on average or, more specifically, less than 10 Angstroms on average. The colloidal nanoparticles may have a narrow size distribution. For example, monodispersed silica sol of size (Dm) of 13.5 Angstroms with standard deviation (σ) of 1.1 showing narrow size distribution (8%) may be used. As described above, these such small colloidal nanoparticles result in formation of small pores in sol-gel layers thereby reducing pore volume and overall porosity. Furthermore, smaller particle sizes allow to significantly decrease curing temperature or, more specifically, sintering temperature, as described above.

A sol-gel solution synthesized during operation 202 may be a stable colloidal dispersion. The stable dispersion may be obtained by using a particular combination of precursors and processing conditions, such as durations of reaction, hydrolysis, and condensation processing stages and temperatures during each stage.

In some embodiments, synthesizing a sol-gel solution during operation 202 may involve sol-gel reaction of metal organic compounds. These compounds may be hydrolyzed and condensed in presence of organic solvents, water, catalysts, stabilizers, colloidal nanoparticles dispersions, rheological agents, surface tension agents, and various combinations thereof. Time, temperature and atmosphere (argon, nitrogen or air) may be controlled to form hybrid (organic-inorganic) polymers. These polymers are later cured to produce metal oxides and/or fluorides or, more generally, to form a sol-gel layer.

Metal organic compounds may be selected from network-forming metal alkoxide of the general formula RₓM(OR′)_{z-x} where R is an organic radical, M is selected from the group consisting of silicon, aluminum, titanium, zirconium, stannum and mixtures thereof each R′ is independently an alkyl radical, z is the valence of M, and x is a number less than z and may be zero. Some examples of silicon alkoxides include, but are not limited to, silicon methoxide, silicon ethoxide, glycidyloxypropyl)-trimethoxysilane and oligomers thereof. Examples of titanium alkoxides include, but are not limited to, titanium methoxide, titanium ethoxide, titanium n-propoxide, titanium n-butoxide, titanium tert-butoxide, titanium isobutoxide, titanium methoxypropoxide, titanium stearyloxide and titanium 2-ethyl hexyoxide. Examples of titanium alkoxide halide such as titanium alkoxide chloride include titanium chloride trisopropoxide and titanium dichloride diethoxide. Examples of solvents include, but are not limited to, ethanol, isopropanol, n-propanol, terpineol, and the like. Examples of acidic catalysts include, but are not limited to, acetic acid, itaconic acid, nitric acid, phosphoric acid, hydrochloric acid, sulfamic acid, formic acid, oxalic acid and the like. Consequently, hydrolyzing of metal organic compound may be performed at a pH of between 2 and 5.

Examples of stabilizers, which may be used in sol-gel solutions include, but are not limited to, beta-diketones, etilenglicol, polyethyleneglicol, diethanolamine, diethylendiamine, N,N-dimethylethanolamine, and the like. Examples of rheological agents used for viscosity adjustment and preparation of thicker crack-free films include, but are not limited to, polyvinylpyrrolidone (pvp), polysaccharides or other non-ionic polymers. Examples of surface tension agents (surfactants) used for surface tension reduction, foam control, and viscosity stabilization, include, but are not limited to, non-ionic SURFYNOL 104DPM and DYNOL 604 (both available from Air Products and Chemicals, Inc. in Allentown, Pa.) and the like. Some additional examples are described below. Examples of commercial colloidal nanoparticles, additional functionalities-impairing (anti-reflective, higher abrasion, color change, specific UV-visual-IR reflecting and absorbance, conductivity and low-emissivity, hydrophobic and/or hydrophilic properties, diffusion barrier etc.) include, but not limited to nanopowders and nanodispersions from Nissan Chemicals, US Research Nanomaterials Inc, Nyacol Nano Technologies Inc, and Evonik Industries.

In some embodiments, a sol-gel solution may include filler particles, such as inorganic particles. For example, corundum particles (a-alumina) may be added to a sol-gel solution used to form silica matrix. Addition of corundum particles may improve scratch resistance/abrasion resistance. The high-density silica matrix has a hardness of about 6.5 (Mohs scale) without corundum particles. The composite of the high-density silica matrix with the corundum particles have shown a hardness of 8-8.5 (Mohs scale), with the maximum material hardness on this scale being 10 for diamond.

Zirconia particles may be added to a solution used to form an amorphous silica-alumina sol-gel layer, e.g., to improve diffusion barrier properties of this layer. In some embodiments, this combination may be used to form a stain resistant glass, e.g., when this composite layer is applied to the glass. The zirconia particles are corrosion resistant and crystalline. This composite layer has proven to be chemical resistant, even at high temperatures in alkali and acid environments.

In some embodiments, ITO-particles may be added to a sol-gel solution to improve conductivity and optical properties of the resulting layer to the substrate.

In some embodiments, larger colloidal nanoparticles may be added to the sol-gel solution containing smaller colloidal nanoparticles. The larger colloidal nanoparticles may have a mean size of between about 1 nanometer and 100 nanometers or, more specifically, between 10 nanometers and 100 nanometers. The larger colloidal nanoparticles may be used for controlling porosity (e.g., when a larger porosity is needed), appearance (e.g., addition of larger colloidal nanoparticles results in haze appearance of the resulting sol-gel layer), and other purposes.

Additional functionalities (e.g., anti-reflective, higher abrasion, color change, specific UV-visual-IR reflecting and absorbance, hydrophobic and/or hydrophilic properties, diffusion barrier etc.) may be achieved using nanopowders and nanodispersions (for example, SNOWTEX®, available from Nissan Chemicals in Japan) dispersions and nanopowders available from US Research Nanomaterials, Inc. and Nyacol Nano Technologies Inc, LUIDOX® colloidal silica, available from W.R. Grace & Co., Columbia, Md., and the like). These nanopowders and nanodispersions may be integrated during synthesis of the sol-gel solution. This integration may be used for controlling of stability of the solution and for controlling the size distribution of the colloidal nanoparticles formed in the solution. For example, if added colloidal nanoparticles are agglomerated or precipitated during integration to the solution, then the resulting sol-gel layer may be non-uniform and highly porous, which may affect the mechanical and overall performance of this sol-gel layer. To achieve compatibility between the solution and added particles (e.g., added in the form colloidal dispersions) various factors should be considered, such as the dispersion media, pH, particles chemistry and surface modification, stabilization method, and presence of counter ions. The size control during this integration may be achieved using an ultrasonic liquid processor. The ultrasonic frequency vibration of the processor's tip causes cavitation as well as formation and violent collapse of microscopic bubbles. These processes release of significant energy in the cavitation field, which effectively de-agglomerates and reduces the size of particles.

Method 200 proceed with providing substrate 102 during operation 204. Substrate 102 has first surface 102a and second surface 102b. Some examples of substrate 102 are described above. In some embodiments, one or both first surface 102a and second surface 102b may have one or more layers (e.g., other sol-gel layers) disposed on these surfaces. Alternatively, both first surface 102a and second surface 102b may be exposed at this operating stage.

In some embodiments, method 200 comprises treating first surface 102a of substrate 102 during optional operation 206. For example, hydroxyl groups or other suitable groups may be formed on the surface of a glass substrate or, more specifically, on the surface of a freshly produced glass substrate. Various chemical glass cleaning agents, such as sodium carbonate (e.g., 10-25%), sodium dodecylbenzenesulfonate (e.g., 1-10%), non-ionic detergent (e.g., 1-10%), and various combinations thereof, may be used. Other components of suitable treatment agents include, but are not limited to, dilute hydrofluoric acid, dilute phosphoric acid, sodium citrate solution, disodium salt (in a solution also comprising ethylenediaminetetraacetic acid and citric acid), polishing agents' slurries (e.g., cerium oxide, aluminum oxide, zirconium oxide, and/or silicon carbide), and the like. In some embodiments, ultrasonic cleaning and/or plasma surface activation may be used during operation 206.

Method 200 then proceeds with forming first sol-gel layer 110 over first surface 102a of substrate 102, during operation 210. Forming operation 210 may comprise distributing the sol-gel solution over first surface 102a of substrate 102 during operation 214. Operation 214 may include dip, spin, roller, slit-and-spin, capillary, spray, ultrasonic spray, flow coaters, and the like.

Operation 214 may involve specifically controlled condensation reactions. For example, a condensation reaction may be performed in the air atmosphere with controlled of humidity (e.g., 20-70% as noted above). The temperature of the environment may be between 20° C. and 25° C. The duration of the condensation reaction may be also controlled to between 1 min and 30 min. Without being restricted to any particular theory, it is believed that controlling relative humidity at 20-70% (for temperatures of 20-25° C.) results in finalization of hydrolysis and condensation reactions in sol-gel wet layer by controlling the evaporation rate and formation of more uniform layers.

Forming operation 210 may involve curing a layer of the sol-gel solution formed on first surface 102a of substrate 102 during operation 220. More specifically, operation 220 may involve exposing the layer of the sol-gel solution to heat (during optional operation 224) and/or radiation (during optional operation 222). In other words, operation 220 may involve radiative curing or thermal curing. The thermal curing may be performed at a temperature of between 400° C. and 700° C. or, more specifically, between 600° C. and 650° C. It should be noted that these temperatures are compatible with various glass processing operations. In fact, in some embodiments, some glass processing techniques (e.g., glass shaping or tempering) may be combined with sol-gel curing. In other words, these operations are performed simultaneously during the same heating cycle thereby reducing energy consumption during the overall process and simplifying the process flow. The duration of the heat treatment may be between 5 min and 2 hours.

In some embodiments, radiative curing (e.g., UV curing, IR curing, and the like) providing similar energy levels may be used (operation 222). For example, photonic curing technology allows fast and effective curing of suitable sol-gel layers without substrate heating. The photonic curing involves applying intense pulse of light (e.g., in a UV-visual region) to colloidal nanoparticles. The colloidal nanoparticles absorb this photons energy causing local heating, which in turn promotes organic components decomposition and colloidal nanoparticles sintering. The radiative curing approach may be suitable for soda-lime glass treatments before or during glass shaping (e.g., forming curved automotive windshields). Radiating curing may be also suitable when heat sensitive substrates are used, such as flexible polymeric materials.

In some embodiments, forming operation 210 comprises changing the shape of substrate 102 during optional operation 226. For example, the shape of substrate 102 may be changed while curing the sol-gel solution (e.g., operation 226 may be a part of operation 220). Alternatively, operation 226 may be a separate operation,

In some embodiments, method 200 further comprises forming one or more additional sol-gel layers, as shown by decision block 240. For example, second sol-gel layer 120 may be formed over first surface 102a of substrate 102. Second sol-gel layer 120 may be formed before first sol-gel layer 110. Similar to first sol-gel layer 110, second sol-gel layer 120 may have a porosity of less than 1%. Furthermore, second sol-gel layer 120 may be formed using radiative curing and/or thermal curing. The thermal curing may be performed at a temperature of between 400° C. and 700° C. Various examples of stack 100 having multiple sol-gel layers are described above with reference to FIGS. 1B-1G.

In some embodiments, method 200 further comprises laminating substrate 102 comprising first sol-gel layer 110 to an additional substrate during optional operation 250. The additional substrate may be laminated to second surface 102b of substrate 102 as, for example, shown in FIGS. 1E and 1F.

### Experimental Results

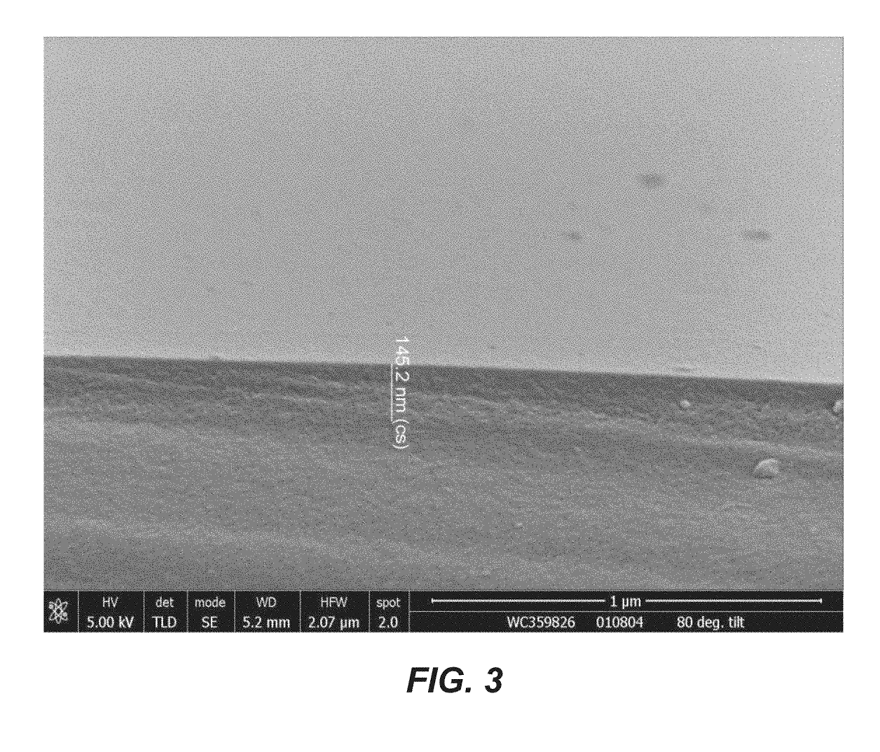

A series of experiments were conducted to determine various properties of stacks comprising substrates and sol-gel layers disposed over these substrates. FIG. 3 illustrates a scanning electron microscope (SEM) image of an interface formed by a glass substrate and one example of a sol-gel layer described herein. Clearly, the sol-gel layer illustrated in FIG. 3 has a much lower porosity in comparison to the conventional sol-gel layers based on the scale of the illustrated image. The porosity of the former sample is estimated to be less than 1% from the image in FIG. 3. A few selected properties for uncoated glass, a glass coated with a conventional high porosity (1-10%) sol-gel layer, and a glass coated with a proposed low porosity sol-gel (less than 1%) layer are presented in the table below.

TABLE 1

| | Initial | Initial | Final | Final Hz | |
|---|---|---|---|---|---|
| Sample | Tvis (%) | Hz (%) | Tvis (%) | (%) | Δ % Haze |
| Uncoated glass | 93.0 ± 0.00 | 0.04 ± 0.00 | 92.1 ± 0.00 | 1.64 ± 0.04 | 1.60 |
| Typical porosity (1-10%) | 96.0 ± 0.05 | 0.23 ± 0.00 | 94.8 ± 0.10 | 3.68 ± 0.03 | 3.45 |
| sol-gel coated glass | | | | | |
| Low porosity (<1%) sol- | 95.8 ± 0.03 | 0.03 ± 0.00 | 94.5 ± 0.11 | 0.65 ± 0.03 | 0.62 |
| gel coated glass | | | | | |

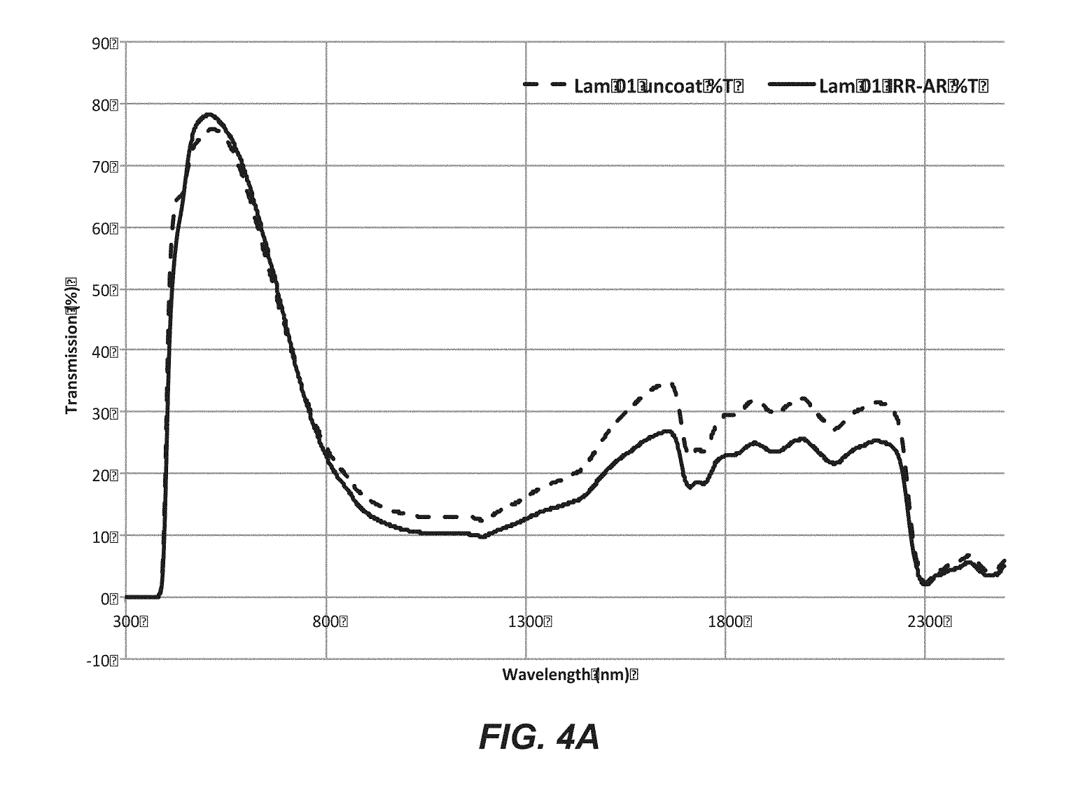

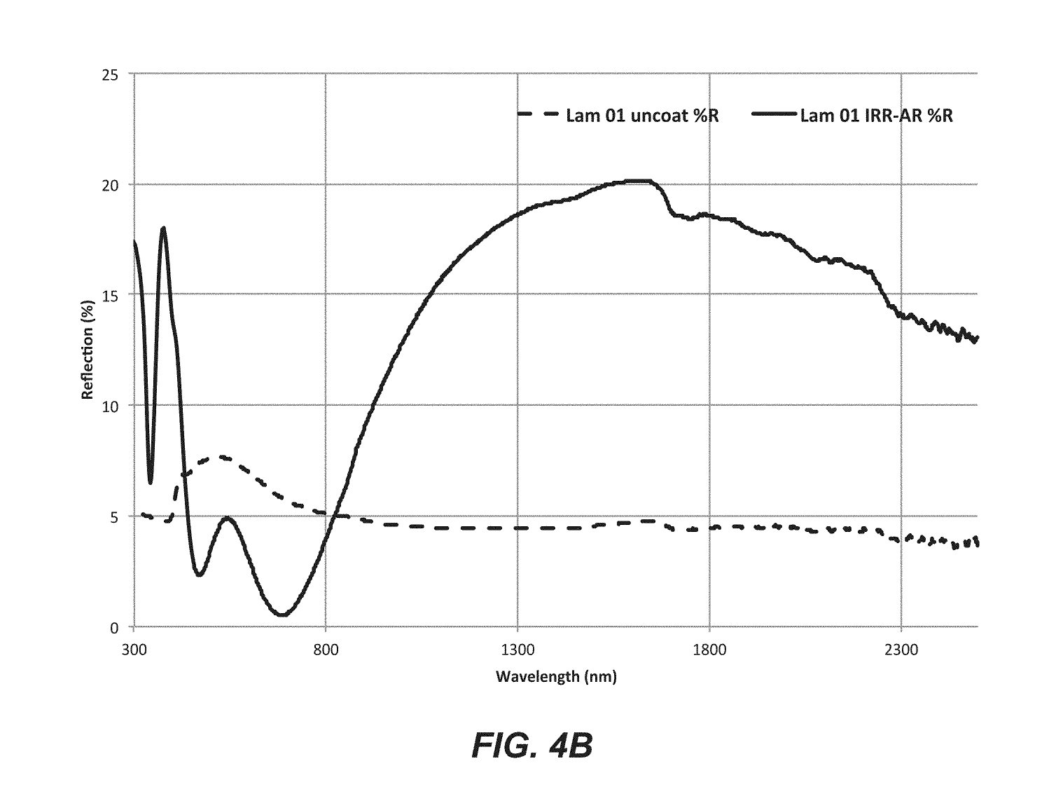

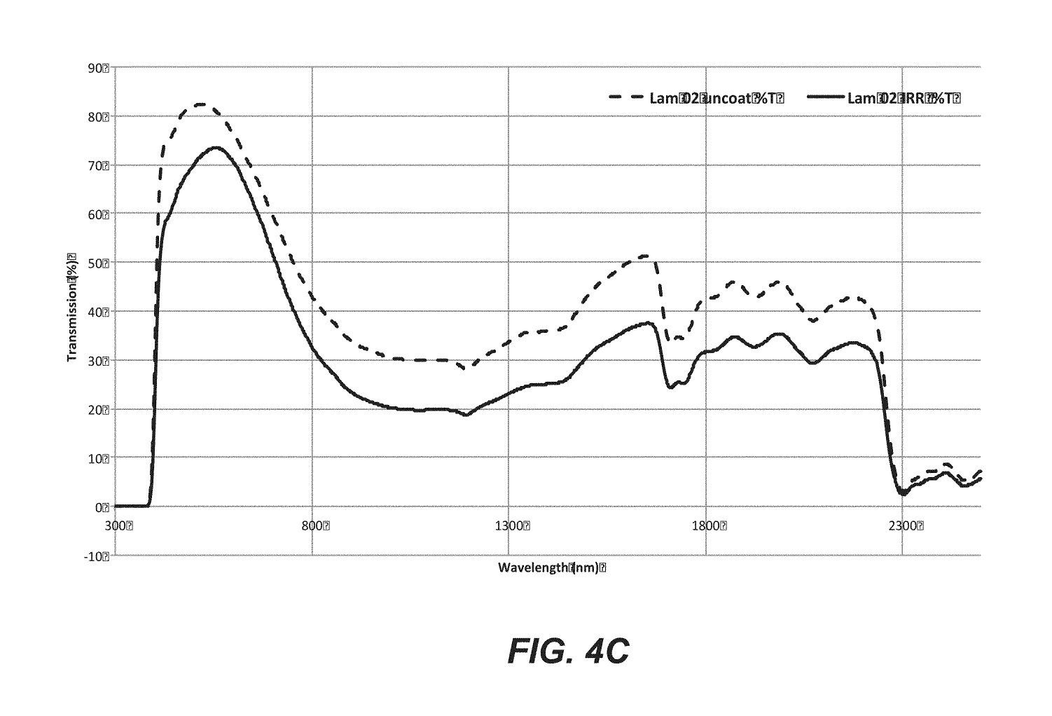

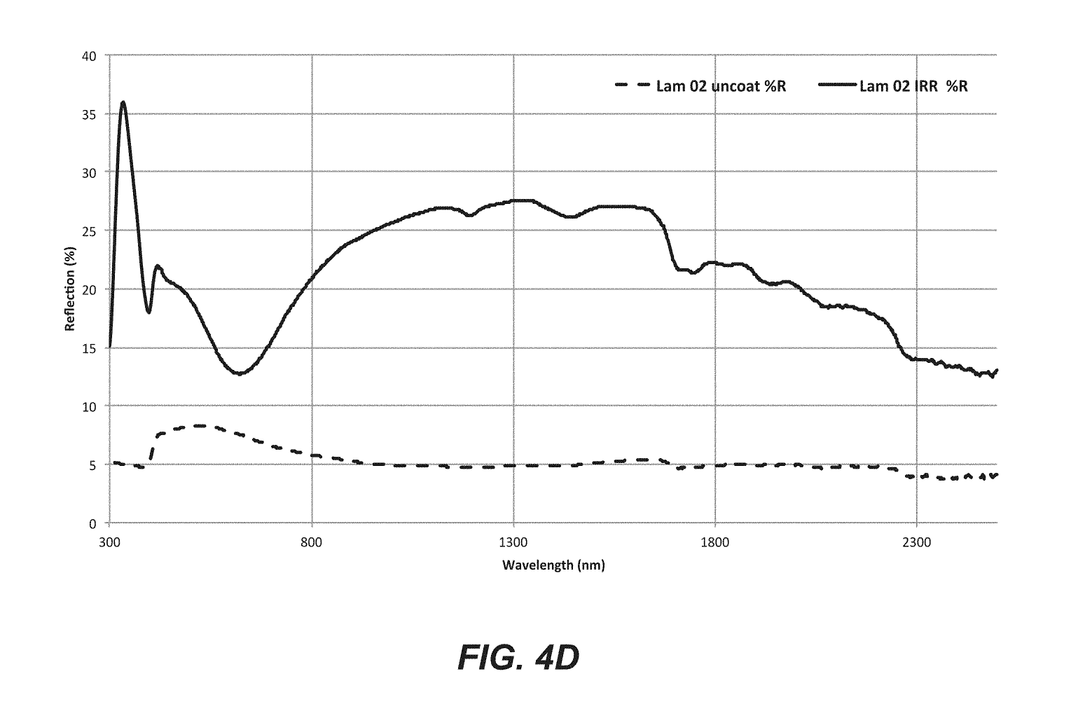

Another test was conducted with two types of substrates. The first substrate was two 2.1-mm thick “green” glass sheets laminated together using a 0.76-mm thick polyvinyl butyral (PVB) layer. This first substrate may be referred to as a “green-green” substrate. The second substrate was similar to the first “green-green” substrate but one 2.1-mm thick “green” glass sheet was replaced with 2.5-mm thick “clear” glass sheets. This second substrate may be referred to as a “clear-green” substrate. Uncoated substrates of both types were used as references. Test samples included two sol-gel layers disposed on one of the glass sheets. The first (outer) sol-gel layer was formed from silicon dioxide, while the second (inner) sol-gel layer was formed from titanium oxide. The second sol-gel layer was formed directly on the glass sheet, while the first sol-gel layer was formed on the second sol-gel layer. All samples (reference and test samples) were tested for various optical and mechanical properties. The results of these tests are presented in the table below Table 2 and FIGS. 4A-4D.

TABLE 2

| | | | | | | |
|---|---|---|---|---|---|---|
| Sample | % Tvis | % Rvis | % Tds | % Rds | SHGC | ΔHz (%) |

First “Green-Green” Substrate

| | | | | | | |
|---|---|---|---|---|---|---|
| Uncoated | 69.9 | 7.3 | 40.2 | 5.6 | 0.55 | 1.31 ± 0.05 |
| Coated | 72.5 | 3.3 | 38.3 | 12.1 | 0.52 | 0.72 ± 0.05 |

Second “Clear-Green” Substrate

| | | | | | | |
|---|---|---|---|---|---|---|
| Uncoated | 78.4 | 8.1 | 51.6 | 6.2 | 0.63 | 1.29 ± 0.06 |
| Coated | 70.1 | 16.8 | 41.4 | 19.2 | 0.53 | 0.80 ± 0.08 |

Each of these tested parameters and corresponding results will now be described in more details. The first parameter column (labeled as % Tvis) represents a percentage of visible light (380-780 nm) transmission. The test was performed in accordance with ASTM E308/CIE. The second parameter column (labeled as % Rvis) represents a percentage of visible light (380-780 nm) reflection. Addition of the sol-gel layer to the first “green-green” substrate substantially increased its visible light transmission and reduced its visible light reflection (from 7.3% to 3.3%). As such, the sol-gel layer effectively functions as an antireflective layer. The third parameter column (labeled as % Tds) represents a percentage of total direct solar light (300-2500 nm) transmission. The fourth parameter column (labeled as % Rds) represents a percentage of total direct solar light (300-2500 nm) reflection. Addition of the sol-gel layer to both substrates substantially increases their total direct solar light reflection, i.e., from 5.6% to 12.1% for the first “green-green” substrate and from 6.2% to 19.2% for the second “clear-green” substrate. Because most of the total direct solar light falls within the infrared (IR) spectrum, the sol-gel layer effectively functions as an infrared reflective layer. The fifth parameter column (labeled SHGC) represent a solar heat gain coefficient, which is a fraction of the total incident solar radiation that is transmitted through the sample and that is also absorbed by the sample and radiated to the interior. Addition of the sol-gel layer to both substrates substantially decreases the solar heat gain coefficient values, i.e., from 0.55 to 0.52 for the first “green-green” substrate and from 0.63 to 0.53 for the second “clear-green” substrate. This also support the above-point that the sol-gel layer effectively functions as an infrared reflective layer. Finally, the sixth parameter column (labeled ΔHz) represents the change in Haze value after 1,000 cycles of abrasion action. Addition of the sol-gel layer to both substrates substantially decreases the change in Haze value, i.e., from 1.31 to 0.72 for the first “green-green” substrate and from 1.29 to 0.80 for the second “clear-green” substrate. As such, the sol-gel layer effectively functions as a scratch resistant layer.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

1. A method of forming a stack, the method comprising:
providing a glass substrate having a first surface and a second surface;
forming a first sol-gel layer over the first surface of the substrate,
wherein the sol-gel layer forms an outer surface of the stack,
wherein the first sol-gel layer has a porosity of less than 1%,
wherein forming the first sol-gel layer comprising radiative curing or a thermal curing at a temperature of between 400° C. and 700° C.

2. The method of claim 1,
wherein forming the first sol-gel layer comprises distributing a sol-gel solution over the first surface of the substrate, and
wherein the sol-gel solution comprises colloidal nanoparticles having a size of less than 20 Angstroms on average.

3. The method of claim 2, wherein the colloidal nanoparticles have the size of less than 10 Angstroms on average.

4. The method of claim 1, further comprises, prior to forming the first sol-gel layer, treating the first surface using a treating solution.

5. The method of claim 4, wherein the treating solution comprises sodium carbonate and sodium dodecylbenzenesulfonate.

6. The method of claim 1, wherein forming the first sol-gel layer is performed in an air-containing atmosphere having relative humidity of between 40% and 70% for temperatures 20-25° C.

7. The method of claim 1, wherein forming the first sol-gel layer comprises the radiative curing.

8. The method of claim 1, wherein forming the first sol-gel layer comprises the thermal curing at a temperature of between 400° C. and 700° C.

9. The method of claim 1, wherein forming the first sol-gel layer comprises changing shape of the substrate.

10. The method of claim 1, further comprises laminating the substrate comprising the first sol-gel layer to an additional substrate, wherein the additional substrate is laminated to the second surface.

11. The method of claim 1, wherein the first sol-gel layer directly interfacing the first surface of the substrate.

12. The method of claim 1, wherein the first sol-gel layer comprises one or more materials selected from the group consisting of silicon oxide, magnesium fluoride, and aluminum oxide.

13. The method of claim 12, wherein a concentration of the one or more materials in the first sol-gel layer is at least about 99% atomic.

14. The method of claim 1, wherein the first sol-gel layer has a refractive index of between about 1.4 and 1.6.

15. The method of claim 1, further comprises forming a second sol-gel layer over the first surface of the substrate,
wherein the second sol-gel layer has a porosity of less than 1%,
wherein forming the second sol-gel layer comprising radiative curing or a thermal curing at a temperature of between 400° C. and 700° C.,
wherein composition of the first sol-gel layer is different from composition of the second sol-gel layer.

16. The method of claim 15, wherein a refractive index of the first sol-gel layer is less than a refractive index of the second sol-gel layer.

17. The method of claim 16, wherein the refractive index of the first sol-gel layer is between about 1.4 and 1.6, and wherein the refractive index of the second sol-gel layer is between about 2.0 and 2.6.

18. The method of claim 17, wherein the second sol-gel layer comprises a material selected from the group consisting of titanium oxide, zirconium oxide, niobium oxide, tantalum oxide, cerium oxide, hafnium oxide, and a transparent conductive oxide.

19. The method of claim 17, wherein the second sol-gel layer is disposed between the substrate and the first sol-gel layer.

20. (canceled)

21. A stack comprising:
a substrate having a first surface and a second surface; and
a first sol-gel layer disposed over the first surface of the substrate and forming an outer surface of the stack,
wherein the first sol-gel layer has a porosity of less than 1%, and
wherein the outer surface of the stack has a surface roughness (Rₐ) of less than 1 nanometer.

22-35. (canceled)
